(19) United States
(12) Patent Application Publication
(10) Pub. No.: US 2026/0054357 A1
(43) Pub. Date: Feb. 26, 2026

(54) Wrench Tools

(71) Applicant: Milwaukee Electric Tool Corporation, Brookfield, WI (US)

(72) Inventors: Christian R. Braun, Milwaukee, WI (US); Kyle A. Ritz, Burlington, WI (US); Jedidiah J. Babinec, Milwaukee, WI (US); Tyler J. Smith, Milwaukee, WI (US)

(21) Appl. No.: 19/314,284

(22) Filed: Aug. 29, 2025

Related U.S. Application Data
(63) Continuation of application No. PCT/US2025/042591, filed on Aug. 19, 2025.
(60) Provisional application No. 63/685,520, filed on Aug. 21, 2024.

(51) Int. Cl. B25B 13/48

(52) U.S. Cl. CPC B25B 13/481

(57) ABSTRACT

Various embodiments of wrenches are provided. Various embodiments described herein provide an improved mechanism for actuating a moveable jaw with respect to a fixed jaw, thereby facilitating use within confined spaces. Various other embodiments of wrenches described herein can be placed in different configurations to facilitate use within confined spaces.

### CROSS-REFERENCE TO RELATED PATENT APPLICATIONS

The present application is a continuation of International Patent Application No. PCT/US2025/042591, filed on Aug. 19, 2025, which claims the benefit of and priority to U.S. Provisional Application No. 63/685,520 filed on Aug. 21, 2024, which is incorporated herein by reference in its entirety.

### BACKGROUND OF THE INVENTION

The present disclosure is directed generally to the field of hand tools. The present disclosure relates specifically to wrenches, such as wrenches for plumbing applications.

### SUMMARY OF THE INVENTION

One embodiment of the invention relates to an adjustable wrench including a handle extending along a longitudinal axis, a fixed jaw rigidly coupled to the handle, the fixed jaw including a first contact surface, a moveable jaw slidably coupled to the handle, a trigger coupled to the handle, and a plurality of projections rigidly coupled to the moveable jaw and extending away from the moveable jaw. The moveable jaw includes a second contact surface facing the first contact surface. The moveable jaw is adjustable between a closed position in which the moveable jaw is engaged with the fixed jaw and an open position in which the moveable jaw is spaced a distance from the fixed jaw. The trigger actuates between an unlocked position in which the moveable jaw is slidable with respect to the handle, and a locked position in which the moveable jaw is not slidable with respect to the handle. The plurality of projections are configured to facilitate a user sliding the moveable jaw with respect to the fixed jaw when the trigger is in the unlocked position.

Another embodiment of the invention relates to an adjustable wrench including a handle extending along a longitudinal axis, a fixed jaw rigidly coupled to the handle, the fixed jaw including a first contact surface, a moveable jaw slidably coupled to the handle, a trigger coupled to the handle, and a gear rack extending within the handle. The trigger engages with the gear rack when the trigger is in the locked position. The moveable jaw includes a second contact surface facing the first contact surface, and the moveable jaw is adjustable between a closed position in which the moveable jaw is engaged with the fixed jaw and an open position in which the moveable jaw is spaced a distance from the fixed jaw. The trigger actuates between an unlocked position in which the moveable jaw is slidable with respect to the handle, and a locked position in which the moveable jaw is not slidable with respect to the handle.

Another embodiment of the invention relates to an adjustable wrench including a handle extending along a longitudinal axis, a fixed jaw rigidly coupled to the handle, the fixed jaw including a first contact surface, a moveable jaw slidably coupled to the handle, a trigger coupled to the handle, and a first projection extending away from the moveable jaw, the first projection configured to facilitate a user sliding the moveable jaw with respect to the fixed jaw when the trigger is in the unlocked position. The moveable jaw includes a second contact surface facing the first contact surface, and the moveable jaw is adjustable between a closed position in which the moveable jaw is engaged with the fixed jaw and an open position in which the moveable jaw is spaced a distance from the fixed jaw. The trigger actuates between an unlocked position in which the moveable jaw is slidable with respect to the handle, and a locked position in which the moveable jaw is not slidable with respect to the handle. The moveable jaw is between the trigger and the fixed jaw along an axis parallel to the longitudinal axis.

Various embodiments of the invention relate to a tool such as a fastener engaging tool, such as a wrench. In specific embodiments, the wrench includes a quick adjust mechanism that allows for quick/easy adjustment of jaw size. In specific embodiments, the wrench allows for ease of use in tight spaces.

Additional features and advantages will be set forth in the detailed description which follows, and, in part, will be readily apparent to those skilled in the art from the description or recognized by practicing the embodiments as described in the written description included, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a side view of an adjustable wrench, according to an exemplary embodiment.

FIG. 2 is a cross-section side view of a portion of the adjustable wrench of FIG. 1, according to an exemplary embodiment.

FIG. 3 is a perspective view of an adjustable wrench, according to an exemplary embodiment.

FIG. 4 is a perspective view of an adjustable wrench, according to another exemplary embodiment.

FIG. 5 is a perspective view of an adjustable wrench, according to another exemplary embodiment.

FIG. 6 is a side view of the adjustable wrench of FIG. 5, according to an exemplary embodiment.

FIG. 7 is a perspective view of the adjustable wrench of FIG. 5, according to an exemplary embodiment.

FIG. 8 is a perspective view of an adjustable wrench, according to an exemplary embodiment.

FIG. 9 is a perspective cross-section view of a portion of the adjustable wrench of FIG. 8, according to an exemplary embodiment.

FIG. 10 is a side cross-section view of a portion of the adjustable wrench of FIG. 8, according to an exemplary embodiment.

FIG. 11 is a side view of a portion of the adjustable wrench of FIG. 8, according to an exemplary embodiment.

FIG. 12 is a side view of a portion of the adjustable wrench of FIG. 8, according to an exemplary embodiment.

FIG. 13 is a schematic side view of a portion of the adjustable wrench of FIG. 8, according to an exemplary embodiment.

FIG. 14 is a front view of a wrench, according to an exemplary embodiment.

FIG. 15 is a perspective view of the adjustable wrench of FIG. 13, according to an exemplary embodiment.

FIG. 16 is a side view of an adjustable wrench, according to an exemplary embodiment.

FIG. 17 is a top view of the adjustable wrench of FIG. 16, according to an exemplary embodiment.

FIG. 18 is a side view of an adjustable wrench, according to an exemplary embodiment.

### DETAILED DESCRIPTION

Referring generally to the figures, various embodiments of a wrench or other fastener engaging tool are provided. In specific embodiments, the wrench includes a quick adjust mechanism that allows for quick/easy adjustment of jaw size. In specific embodiments, the wrench allows for ease of use in tight spaces, such as by being more easily adjustable and/or configurable.

In one embodiment, an adjustable wrench includes a rack gear and trigger mechanism that allows the wrench jaw to be quickly adjusted to the desired size. In another embodiment, a ratcheting adjustable wrench includes a ratchet mechanism that allows the wrench jaw to be quickly adjusted to the desired size. The ratcheting mechanism allows the jaw to quickly disengage from the workpiece/fastener when a force is applied to the handle direction in non-driving or reversed direction. In another embodiment, a wrench is a hand grip wrench having a body with radially outward facing exterior surface to facilitate gripping by a user and one or more insert having a radially inward facing surface designed to engage a fastener, such as a variety of standard plumbing fastener sizes. In another embodiment, a wrench includes a pivot joint between the handle and the head allowing the angle of the head relative to the handle to be adjusted. In another embodiment, the wrench includes a handle with a short length relative to the size of the wrench head/jaws, allowing for the wrench to fit in tight spaces.

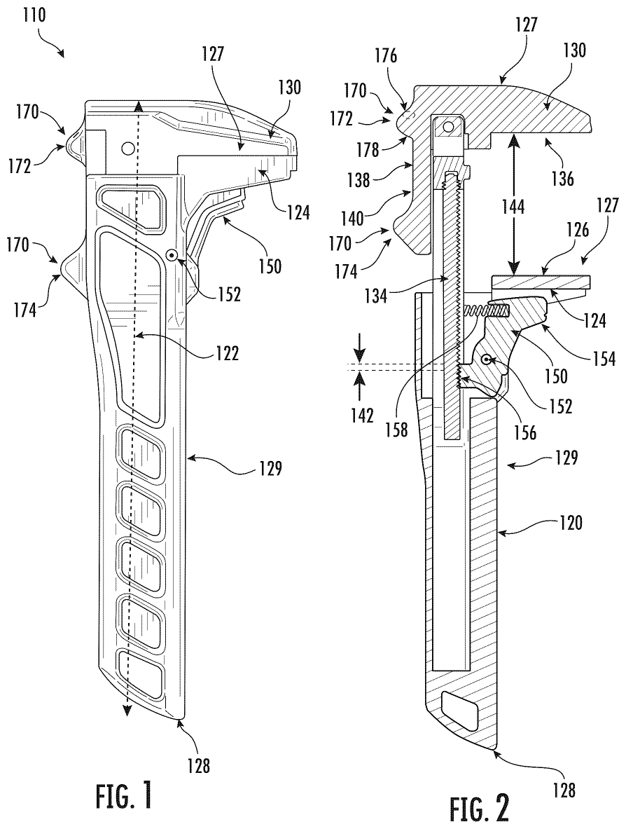

Referring to FIGS. 1-2, various aspects of adjustable wrench 110 are provided. Adjustable wrench 110 includes handle 120 extending along a longitudinal axis 122, a fixed jaw 124 rigidly coupled to the handle 120, a moveable jaw 130 slidably coupled to the handle 120, a trigger 150 coupled to the handle 120, and one or more projections 170 rigidly coupled to the moveable jaw 130 and extending away from the moveable jaw 130.

In various embodiments, adjustable wrench 110 includes plurality of projections 170 rigidly coupled to the moveable jaw 130 and extending away from the moveable jaw 130, the plurality of projections 170 configured to facilitate a user sliding the moveable jaw 130 with respect to the fixed jaw 124 when the trigger 150 is in the unlocked position. In various embodiments, the plurality of projections 170 are aligned with each other along the longitudinal axis 122. In various embodiments, moveable jaw 130 includes arm 138 extending along longitudinal axis 122, and one or more of projections 170 extend from rear surface 140 of arm 138.

In various embodiments, adjustable wrench 110 includes a gear rack 134 rigidly coupled to moveable jaw 130 and extending within the handle 120. In various embodiments gear rack 134 slides within handle 120. The trigger 150 engages with the gear rack 134 when the trigger 150 is in the locked position. Trigger 150 actuates between an unlocked position in which the moveable jaw 130 is slidable with respect to the handle 120, and a locked position in which the moveable jaw 130 is not slidable with respect to the handle 120. Trigger 150 includes a protrusion 156 that engages with gear rack 134, and an interface portion 154 that a user interfaces with to actuate trigger 150. When actuating, trigger 150 rotates about rotational axis 152 with respect to handle 120.

In various embodiments, the moveable jaw 130 is positionable in at least 20 fixed positions with respect to the fixed jaw 124. In various embodiments, the moveable jaw 130 is positionable in no more than 30 fixed positions with respect to the fixed jaw 124. In various embodiments, the plurality of positions are separated by a separation distance 142 that is at least 0.1″. In various embodiments, the moveable jaw 130 is positionable with respect to the fixed jaw 124 such that the second contact surface 136 is a distance 144 that is at least 2″ away from the first contact surface 126.

In various embodiments, first projection 172 extends away from the moveable jaw 130 and a front 129 of the handle 120. The first projection 172 is configured to facilitate a user sliding the moveable jaw 130 with respect to the fixed jaw 124 when the trigger 150 is in the unlocked position. Trigger 150 includes protrusion 156 that engages with the gear rack 134, and the protrusion 156 moves towards the front 129 of the handle 120 when the trigger 150 actuates from the locked position to the unlocked position.

The fixed jaw 124 includes a first contact surface 126, which is planar in various embodiments. The moveable jaw 130 includes a second contact surface 136, which is planar in various embodiments. The moveable jaw 130 is adjustable between a closed position in which the moveable jaw 130 is engaged with the fixed jaw 124 and an open position in which the moveable jaw 130 is spaced a distance from the fixed jaw 124.

In various embodiments, handle 120 extends from a bottom 128 to a top 127, and the fixed jaw 124 is positioned at the top 127. The moveable jaw 130 moves away from the bottom 128 when the moveable jaw 130 moves from the closed position to the open position. In various embodiments, at least a portion 176 of a first projection 172 of the plurality of projections 170 is further from the bottom 128 than the second contact surface 136. In various embodiments, at least a portion 178 of a second projection 174 of the plurality of touchpoints 170 is closer to the bottom 128 than the second contact surface 136.

In various embodiments, a second projection 174 of the plurality of projections 170 is closer to the bottom 128 than the first contact surface 126 when the moveable jaw 130 is in the closed position. In various embodiments, the second projection 174 is positionable further from the bottom 128 than the second contact surface 136 when the moveable jaw 130 is in the open position.

In various embodiments, the trigger 150 is at least partially between the first projection 172 and the second projection 174 along the longitudinal axis 122 when the moveable jaw 130 is in the closed position. In various embodiments, moveable jaw 130 slides along the longitudinal axis 122 with respect to the handle 120. In various embodiments, the trigger 150 extends from a front 129 of the handle 120 opposite the plurality of projections 170.

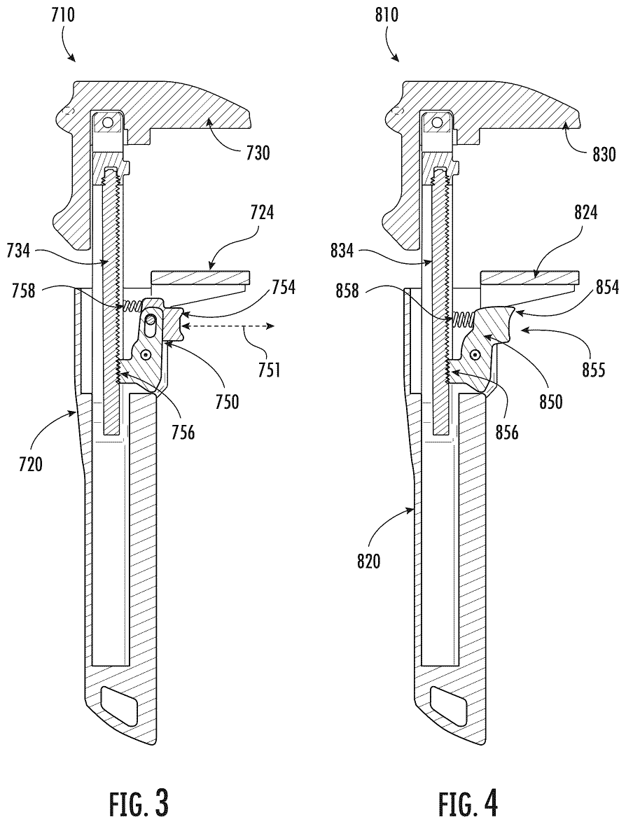

Referring to FIG. 3, various aspects of adjustable wrench 710 are shown. Adjustable wrench 710 is substantially the same as adjustable wrench 110 except for the differences discussed herein.

Adjustable wrench 710 includes trigger 750 pivotally coupled to handle 720, and interface 754 coupled to trigger 754. Interface 754 is coupled to trigger 750 such that interface 754 slides along slidable axis 751 with respect to handle 720 as trigger 750 is rotating with respect to handle 720 between the locked position and the unlocked position. Applicant has observed that providing the user an interface 754 that slides horizontally with respect to handle 720 can facilitate the user actuating trigger 750 to the unlocked position while simultaneously moving movable jaw 730 towards or away from fixed jaw 724.

Spring 758 biases interface 754 away from gear rack 734, thereby resulting in protrusion 756 of trigger 750 being biased to engage with gear rack 734. To slidably actuate movable jaw 730 towards or away from fixed jaw 724, a user engages with interface 754 to move interface 754 towards gear rack 734. As a result, protrusion 756 disengages with gear rack 734, and the user can move movable jaw 730 towards or away from fixed jaw 724.

Referring to FIG. 4, various aspects of adjustable wrench 810 are shown. Adjustable wrench 810 is substantially the same as adjustable wrench 110 or adjustable wrench 710 except for the differences discussed herein.

Adjustable wrench 810 includes trigger 850 pivotally coupled to handle 820, trigger 850 includes interface portion 854. Interface portion 854 includes recess 855 defining a convex surface with respect gear rack 834. Applicant has observed that providing the user an interface portion 854 with a recess 855 can improve the user experience when interacting with trigger 850, such as by facilitating the user actuating trigger to the unlocked position while simultaneously moving movable jaw 830 towards or away from fixed jaw 824.

Spring 858 biases interface portion 854 away from gear rack 834, thereby resulting in protrusion 856 of trigger 850 being biased to engage with gear rack 834. To slidably actuate movable jaw 830 towards or away from fixed jaw 824, a user engages with interface portion 854 to move interface portion 854 towards gear rack 834. As a result, protrusion 856 disengages with gear rack 834, and the user can move movable jaw 830 towards or away from fixed jaw 824.

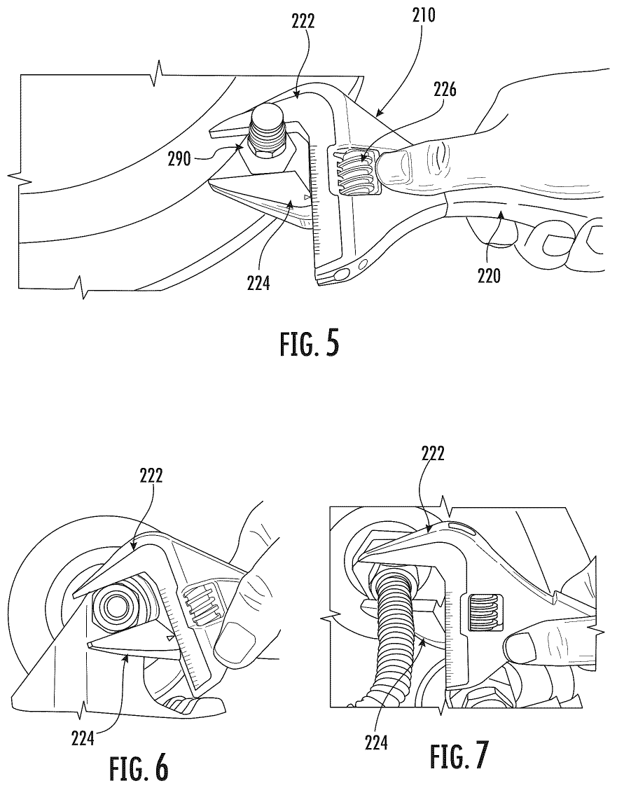

Referring to FIGS. 5-7, various aspects of adjustable wrench 210 are shown. Adjustable wrench 210 is substantially the same as adjustable wrench 110 except for the differences discussed herein.

Adjustable wrench 210 includes handle 220, a fixed jaw 222 rigidly coupled to handle 220, a moveable jaw 224 slidably coupled to fixed jaw 222 and handle 220, and a gear 226. Gear 226 is configured for a user to interface with to slidably actuate moveable jaw 224 closer to and away from fixed jaw 222 to thereby engage and disengage from fastener 290, such as a nut.

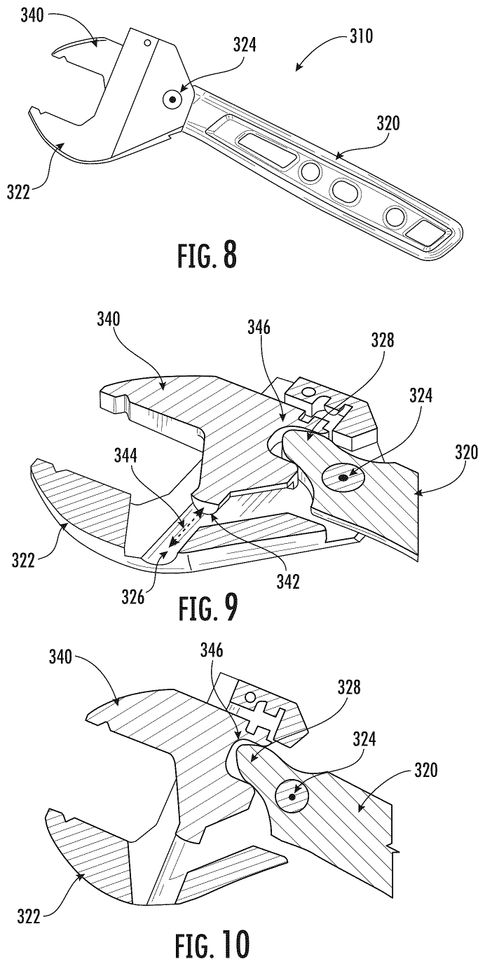

Referring to FIGS. 8-13, various aspects of adjustable wrench 310 are shown. Adjustable wrench 310 is substantially the same as adjustable wrench 110 and adjustable wrench 210 except for the differences discussed herein.

Adjustable wrench 310 includes handle 320, first jaw 322 pivotally coupled to handle 320 such that handle 320 rotates with respect to first jaw 322 about axis 324, and second jaw 340. Second jaw 340 slides with respect to first jaw 322 along axis 344. In particular, first jaw 322 includes channel 326 that receives projection 342 of second jaw 340. As handle 320 rotates about axis 324 with respect to first jaw 322, projection 328 of handle 320 is received within and interfaces with recess 346 of second jaw 230 to thereby slide second jaw 340 with respect to first jaw 322 along axis 344.

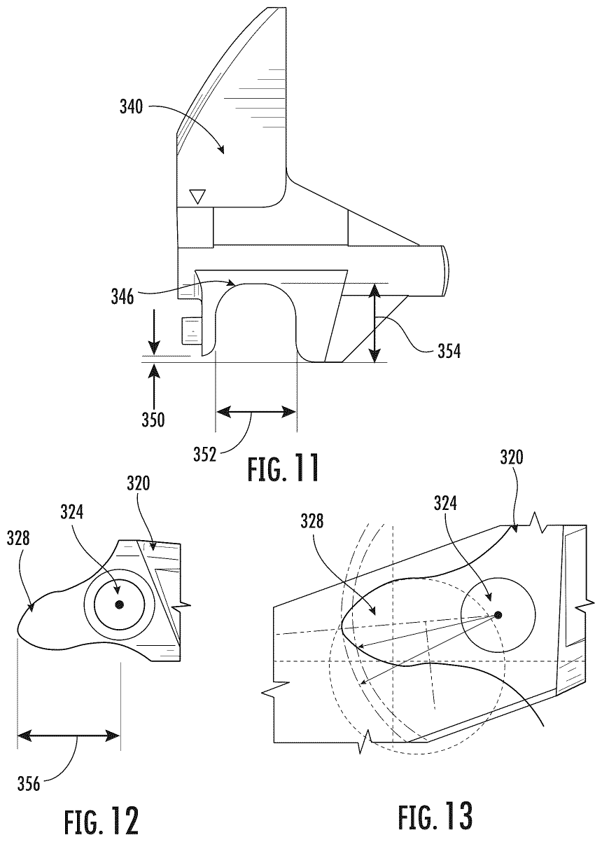

Referring to FIGS. 11-13, various aspects of projection 328 of handle 320 and recess 346 of second jaw 340 are shown. In various embodiments, recess 346 has a width 352 of 12.101 mm. In various embodiments, one side of recess 346 extends distance 350 further from second jaw 340 than the other side, and distance 350 is 0.983 mm. In various embodiments, recess 346 extends distance 354 away from body of moveable jaw 340, and distance 354 is 11.798 mm. In various embodiments, projection 328 extends distance 356 from axis 324, and distance 356 is 20.838 mm.

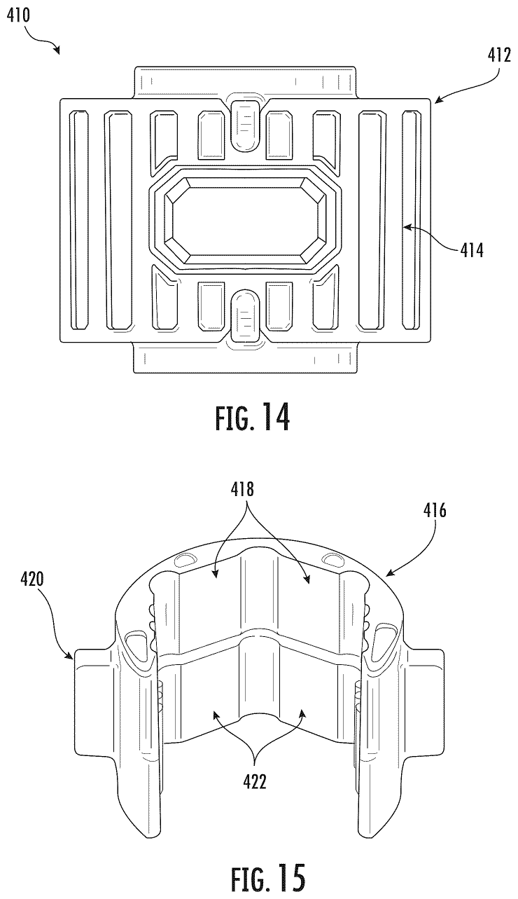

Referring to FIGS. 14-15, various aspects of wrench 410 are shown. Wrench 410 includes handle 412 including outer surfaces 414 against which a user grips handle 412, and one or more inserts, such as first insert 416 and second insert 420. Applicant has observed that providing a wrench including inserts with this configuration and reduced size facilitates users rotating fasteners in constricted spaces. First insert 416 includes inner surfaces 418 that interface with fasteners and second insert 420 includes inner surfaces 422 that interface with fasteners. In various embodiments, first insert 416 and second insert 420 have different sizes and are thus configured to engage with different sized fasteners, thereby facilitating how quickly a user can engage with different sized fasteners (e.g., by flipping wrench 410 upside down so the other insert engages with the fastener).

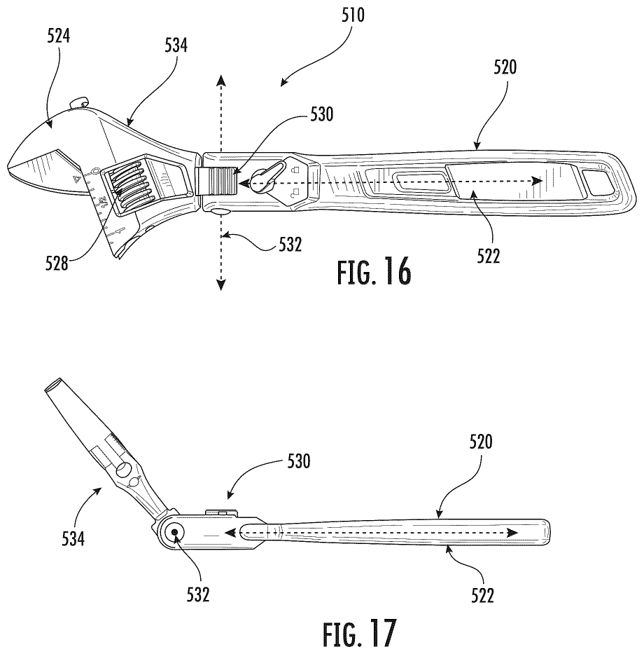

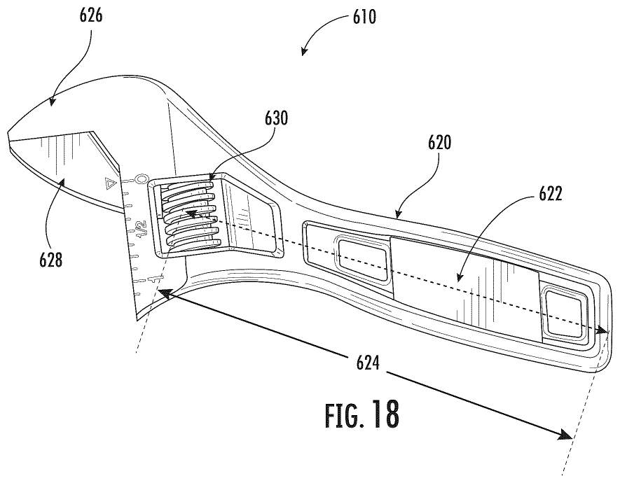

Referring to FIGS. 16-17, various aspects of adjustable wrench 510 are shown. Adjustable wrench 510 is substantially the same as adjustable wrench 110, adjustable wrench 210 and adjustable wrench 310 except for the differences discussed herein.

Adjustable wrench 510 includes handle 520 extending along longitudinal axis 522, and head 534 pivotally coupled to handle 520 such that head 534 rotates rotational axis 532 with respect to handle 520.

Head 534 includes paddle 530 that actuates between a locked position and an unlocked position. When paddle 530 is in the locked position, head 534 is biased to remain stationary with respect to handle 520. When paddle 530 is in the unlocked position, head 534 is permitted to rotate with respect to handle 520. Applicant has observed that making head 534 adjustable with respect to handle 520 facilitates using adjustable wrench 510 in confined spaces.

Head 534 includes fixed jaw 524, moveable jaw 526 positionable with respect to fixed jaw 524 by a user actuating gear 528.

Referring to FIG. 18, various aspects of wrench 610 are shown. Wrench 610 includes handle 620 extending distance 624 along longitudinal axis 622, fixed jaw 626, and moveable jaw 628 that is positionable with respect to fixed jaw 626 by a user actuating gear 630. In various embodiments, handle 620 extends a reduced distance, such as 4″, thereby permitting wrench 610 to be used in confined spaces.

Additional details are shown and described in the accompanying figures.

It should be understood that the figures illustrate the exemplary embodiments in detail, and it should be understood that the present application is not limited to the details or methodology set forth in the description or illustrated in the figures. It should also be understood that the terminology is for description purposes only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one. As used herein, “rigidly coupled” refers to two components being coupled in a manner such that the components move together in a fixed positional relationship when acted upon by a force.

Various embodiments of the disclosure relate to any combination of any of the features, and any such combination of features may be claimed in this or future applications. Any of the features, elements or components of any of the exemplary embodiments discussed above may be utilized alone or in combination with any of the features, elements or components of any of the other embodiments discussed above.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. An adjustable wrench comprising:
a handle extending along a longitudinal axis;
a fixed jaw rigidly coupled to the handle, the fixed jaw comprising a first contact surface;
a moveable jaw slidably coupled to the handle, the moveable jaw comprising a second contact surface facing the first contact surface, wherein the moveable jaw is adjustable between a closed position in which the moveable jaw is engaged with the fixed jaw and an open position in which the moveable jaw is spaced a distance from the fixed jaw;
a trigger coupled to the handle, the trigger actuating between an unlocked position in which the moveable jaw is slidable with respect to the handle, and a locked position in which the moveable jaw is not slidable with respect to the handle; and
a plurality of projections rigidly coupled to the moveable jaw and extending away from the moveable jaw, the plurality of projections configured to facilitate a user sliding the moveable jaw with respect to the fixed jaw when the trigger is in the unlocked position.

2. The adjustable wrench of claim 1, wherein the plurality of projections are aligned with each other along the longitudinal axis.

3. The adjustable wrench of claim 2, the handle extending from a bottom to a top, wherein the moveable jaw moves away from the bottom when the moveable jaw moves from the closed position to the open position, wherein at least a portion of a first projection of the plurality of projections is further from the bottom than the second contact surface.

4. The adjustable wrench of claim 3, wherein a second projection of the plurality of projections is closer to the bottom than the first contact surface when the moveable jaw is in the closed position.

5. The adjustable wrench of claim 4, wherein the second projection is positionable further from the bottom than the second contact surface when the moveable jaw is in the open position.

6. The adjustable wrench of claim 4, wherein the trigger is at least partially between the first projection and the second projection along the longitudinal axis when the moveable jaw is in the closed position.

7. The adjustable wrench of claim 1, wherein the moveable jaw slides along the longitudinal axis with respect to the handle.

8. The adjustable wrench of claim 1, wherein the first contact surface is planar.

9. The adjustable wrench of claim 8, wherein the second contact surface is planar.

10. The adjustable wrench of claim 1, wherein the trigger extends from a front of the handle opposite the plurality of projections.

11. An adjustable wrench comprising:
a handle extending along a longitudinal axis;
a fixed jaw rigidly coupled to the handle, the fixed jaw comprising a first contact surface;
a moveable jaw slidably coupled to the handle, the moveable jaw comprising a second contact surface facing the first contact surface, wherein the moveable jaw is adjustable between a closed position in which the moveable jaw is engaged with the fixed jaw and an open position in which the moveable jaw is spaced a distance from the fixed jaw;
a trigger coupled to the handle, the trigger actuating between an unlocked position in which the moveable jaw is slidable with respect to the handle, and a locked position in which the moveable jaw is not slidable with respect to the handle; and
a gear rack extending within the handle, wherein the trigger engages with the gear rack when the trigger is in the locked position.

12. The adjustable wrench of claim 11, wherein the moveable jaw is positionable in a plurality of positions of at least 20 positions with respect to the fixed jaw.

13. The adjustable wrench of claim 12, wherein the moveable jaw is positionable in no more than 30 positions with respect to the fixed jaw.

14. The adjustable wrench of claim 12, wherein the plurality of positions are separated by a separation distance of at least 0.1″.

15. The adjustable wrench of claim 11, wherein the moveable jaw is positionable with respect to the fixed jaw such that the second contact surface is a distance at least 2″ away from the first contact surface.

16. The adjustable wrench of claim 11, comprising a first projection extending away from the moveable jaw and a front of the handle, the first projection configured to facilitate a user sliding the moveable jaw with respect to the fixed jaw when the trigger is in the unlocked position, wherein the trigger comprises a protrusion that engages with the gear rack, wherein the protrusion moves towards the front of the handle when the trigger actuates from the locked position to the unlocked position.

17. An adjustable wrench comprising:
a handle extending along a longitudinal axis;
a fixed jaw rigidly coupled to the handle, the fixed jaw comprising a first contact surface;
a moveable jaw slidably coupled to the handle, the moveable jaw comprising a second contact surface facing the first contact surface, wherein the moveable jaw is adjustable between a closed position in which the moveable jaw is engaged with the fixed jaw and an open position in which the moveable jaw is spaced a distance from the fixed jaw;
a trigger coupled to the handle, the trigger actuating between an unlocked position in which the moveable jaw is slidable with respect to the handle, and a locked position in which the moveable jaw is not slidable with respect to the handle, wherein the moveable jaw is between the trigger and the fixed jaw along an axis parallel to the longitudinal axis; and
a first projection extending away from the moveable jaw, the first projection configured to facilitate a user sliding the moveable jaw with respect to the fixed jaw when the trigger is in the unlocked position.

18. The adjustable wrench of claim 16, the handle extending from a bottom to a top, wherein the moveable jaw moves away from the bottom when the moveable jaw moves from the closed position to the open position, wherein at least a portion of the first projection is further from the bottom than the second contact surface.

19. The adjustable wrench of claim 18, wherein at least a portion of the first projection is closer to the bottom than the second contact surface.

20. The adjustable wrench of claim 11, wherein the second contact surface is planar.
